(19) United States
(12) Patent Application Publication
(10) Pub. No.: US 2020/0372001 A1
(43) Pub. Date: Nov. 26, 2020

(54) DEDUPLICATION STORAGE METHOD, DEDUPLICATION STORAGE CONTROL DEVICE, AND DEDUPLICATION STORAGE SYSTEM

(71) Applicant: NEC Corporation, Tokyo (JP)

(72) Inventor: Sumudu HIROSE, Tokyo (JP)

(73) Assignee: NEC Corporation, Tokyo (JP)

(21) Appl. No.: 16/877,610

(22) Filed: May 19, 2020

(30) Foreign Application Priority Data
May 20, 2019 (JP) 2019-094437

(51) Int. Cl. G06F 16/174

(52) U.S. Cl. CPC G06F 16/1748

(57) ABSTRACT

A deduplication storage control device of the present invention includes: a data writing part that divides a storage target file into multiple divided data blocks and, in a case where the divided data block is duplicated with the data block stored in the storage device, performs a process of referring to the data block stored in the storage device as the divided data block; and a data update part 122 that stores file information specifying a division source file of the data block stored in the storage device in association with the said data block, and also calculates a reference ratio representing a ratio at which a certain file is referred to by other files based on the file information stored in association with the data block and stores the reference ratio in association with the certain file.

### INCORPORATION BY REFERENCE

This application is based upon and claims the benefit of priority from Japanese patent application No. 2019-094437, filed on May 20, 2019, the disclosure of which is incorporated herein in its entirety by reference.

### TECHNICAL FIELD

The present invention relates to a deduplication storage method, a deduplication storage control device, and a deduplication storage system.

### BACKGROUND ART

In accordance with development and spread of computers in recent years, various kinds of information are digitalized. A device for storing such digital data is, for example, a storage device such as a magnetic tape or a magnetic disk. Because data to be stored increases day by day and reaches a huge amount, a mass storage system is required. It is also required to keep reliability while reducing the cost spent for a storage device. In addition, it is also required to be able to easily retrieve data later. Thus, a storage system is expected to be able to automatically realize increase of storage capacity and performance, eliminate duplicate storage to reduce storage cost, and work with high redundancy.

Under such circumstances, a content-addressable storage system has been developed in recent years as shown in Patent Document 1. In such a content-addressable storage system, data is distributedly stored into a plurality of storage devices, and a storage location where the data is stored is specified by a unique content address specified depending on the content of the data. Some content-addressable storage systems divide predetermined data into a plurality of fragments and store the fragments, together with fragments to become redundant data, into a plurality of storage devices, respectively.

The content-addressable storage system as described above can, by designation of a content address, retrieve data, namely, fragments each stored in a storage location specified by the content address and restore the predetermined data before division by using the fragments later.

The content address is generated based on a value generated so as to be unique depending on the content of data, for example, based on the hash value of data. Thus, in the case of duplicate data, it is possible to acquire data of the same content by referring to data in the same storage location. Therefore, it is unnecessary to separately store the duplicate data, and it is possible to eliminate duplicate recording and reduce the volume of data.

In particular, a storage system which has a function of eliminating duplicate storage as described above compresses data to be written, such as a file, by dividing into a plurality of data blocks of predetermined volumes and then writes into storage devices. By thus eliminating duplicate storage on the basis of the data blocks obtained by dividing the file, a duplication ratio is increased and the volume of data is reduced. Then, by applying the above system to a storage system which performs backup, the volume of a backup is reduced and a bandwidth for replication is restricted.
Patent Document 1: Japanese Unexamined Patent Application Publication No. JP-A 2005-235171

Referring to FIGS. 1 to 3, an example of a case where files are stored with data thereof deduplicated will be described. Firstly, FIG. 1 shows a case where a file 1 and a file 2 are each divided into data blocks and stored on a disk, 30% of data of the respective files are common (duplicated), and the file 2 refers to the 30% of the data of the file 1 as a result of deduplication. A reference ratio of a file n can be calculated by “the size of referred data of the file n/the size of the whole data of the file n.” In the case shown in FIG. 1, even if either of the files is deleted, only data excluding the duplicate data is deleted in size (about ⅔ (70%)).

In the situation shown in FIG. 1, when a new file is written in as shown in FIG. 2, the new file refers to the data blocks of the existing files 1 and 2. Then, as shown in FIG. 3, a reference relation between the files gets complicated and, in a case where any of the files is deleted, it is difficult to grasp what amount of free space becomes available.

Thus, in the case of a storage system that compresses data by the deduplication technology, there is a possibility that a certain data block stored on a disk is referred to by a number of files, and therefore, there is a relation of 1:n between the certain data block and the files. Consequently, there is a problem that when, even if a certain file is deleted or moved (subjected to tiering), a ratio at which data of the file is duplicated with data of different files, that is, data of the file is referred to by different files is high, it is difficult to grasp an effect resulting from acquisition of a free space by file deletion or from tiering operation.

### SUMMARY OF THE INVENTION

Accordingly, an object of the present invention is to solve the abovementioned problem that it is difficult to grasp an effect resulting from acquisition of a free space by file deletion or from tiering operation.

A deduplication storage method according to an example aspect of the present invention includes: dividing a storage target file into a plurality of divided data blocks; in a case where a divided data block is not duplicated with a data block stored in a storage device, storing the divided data block into the storage device; in a case where the divided data block is duplicated with the data block stored in the storage device, performing a process of referring to the data block stored in the storage device as the divided data block; and storing file information specifying a division source file of the data block stored in the storage device in association with this data block, and also calculating a reference ratio representing a ratio at which a certain file is referred to by other files based on the file information stored in association with the data block and storing the reference ratio in association with the certain file.

Further, a deduplication storage control device according to another aspect of the present invention includes: a data writing part that divides a storage target file into a plurality of divided data blocks, in a case where a divided data block is not duplicated with a data block stored in a storage device, stores the divided data block into the storage device, and in a case where the divided data block is duplicated with the data block stored in the storage device, performs a process of referring to the data block stored in the storage device as the divided data block; and a data update part that stores file information specifying a division source file of the data block stored in the storage device in association with this data block, and also calculates a reference ratio representing a ratio at which a certain file is referred to by other files based on the file information stored in association with the data block and stores the reference ratio in association with the certain file.

Further, a deduplication storage system according to another aspect of the present invention includes a plurality of storage devices and a deduplication storage control device executing control to distribute, deduplicate, and store a storage target file into the plurality of storage devices. The deduplication storage control device includes: a data writing part that divides a storage target file into a plurality of divided data blocks, in a case where a divided data block is not duplicated with a data block stored in a storage device, stores the divided data block into the storage device, and in a case where the divided data block is duplicated with the data block stored in the storage device, performs a process of referring to the data block stored in the storage device as the divided data block; and a data update part that stores file information specifying a division source file of the data block stored in the storage device in association with this data block, and also calculates a reference ratio representing a ratio at which a certain file is referred to by other files based on the file information stored in association with the data block and stores the reference ratio in association with the certain file.

Further, a non-transitory computer-readable storage medium storing a program according to another aspect of the present invention stores a program including instructions for causing an information processing device to realize: a data writing part that divides a storage target file into a plurality of divided data blocks, in a case where a divided data block is not duplicated with a data block stored in a storage device, stores the divided data block into the storage device, and in a case where the divided data block is duplicated with the data block stored in the storage device, performs a process of referring to the data block stored in the storage device as the divided data block; and a data update part that stores file information specifying a division source file of the data block stored in the storage device in association with this data block, and also calculates a reference ratio representing a ratio at which a certain file is referred to by other files based on the file information stored in association with the data block and stores the reference ratio in association with the certain file.

With the configurations as described above, the present invention makes it possible to easily grasp an effect resulting from acquisition of a free space by file deletion or from tiering operation in a deduplication storage.

### BRIEF DESCRIPTION OF DRAWINGS

FIG. 1 is a view showing a state in which a file is stored with data thereof deduplicated;

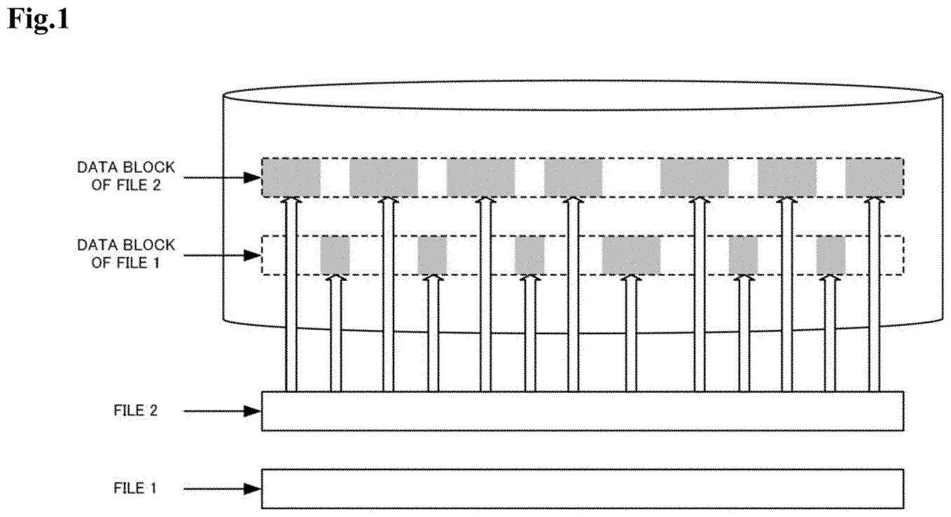

FIG. 2 is a view showing a state in which a file is stored with data thereof deduplicated;

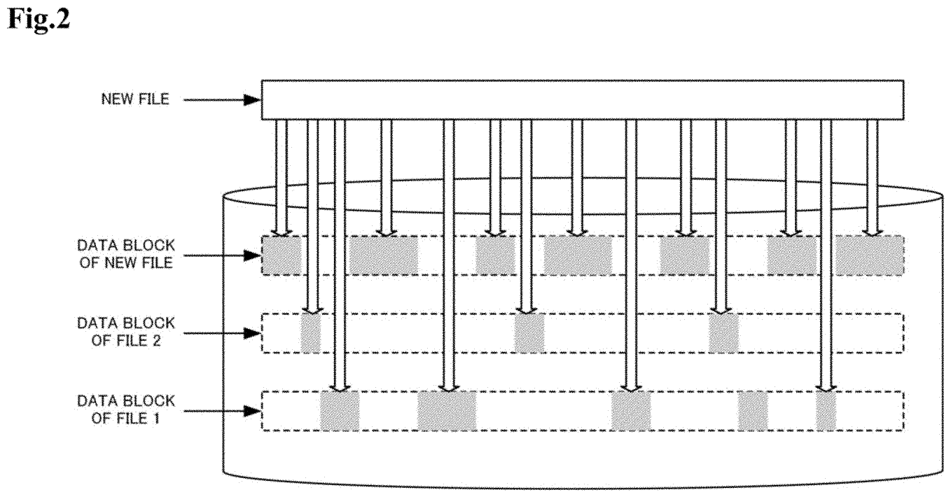

FIG. 3 is a view showing a state in which a file is stored with data thereof deduplicated;

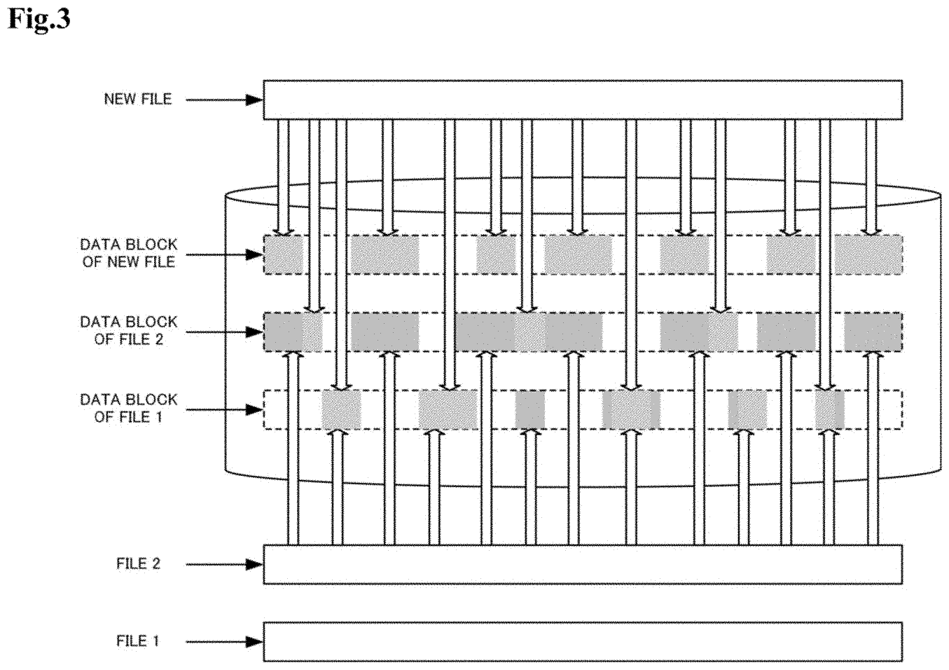

FIG. 4 is a block diagram showing the outline of the configuration of a storage system in a first example embodiment of the present invention;

FIG. 5 is a function block diagram showing the configuration of the storage system in the first example embodiment of the present invention;

FIG. 6 is a description view for describing an aspect of a data writing process in the storage system disclosed in FIG. 5;

FIG. 7 is a description view for describing an aspect of the data writing process in the storage system disclosed in FIG. 5;

FIG. 8 is a flowchart showing an operation in the data writing process in the storage system disclosed in FIG. 5;

FIG. 9 is a flowchart showing an operation in the data writing process in the storage system disclosed in FIG. 5;

FIG. 10 is a flowchart showing an operation in the data writing process in the storage system disclosed in FIG. 5;

FIG. 11 is a flowchart showing an operation of the data writing process in the storage system disclosed in FIG. 5;

FIG. 12 is a block diagram showing a hardware configuration of a deduplication storage control device in a second example embodiment of the present invention;

FIG. 13 is a block diagram showing the configuration of the deduplication storage control device in the second example embodiment of the present invention; and

FIG. 14 is a flowchart showing the operation of the deduplication storage control device in the second example embodiment of the present invention.

### EXAMPLE EMBODIMENT

### First Example Embodiment

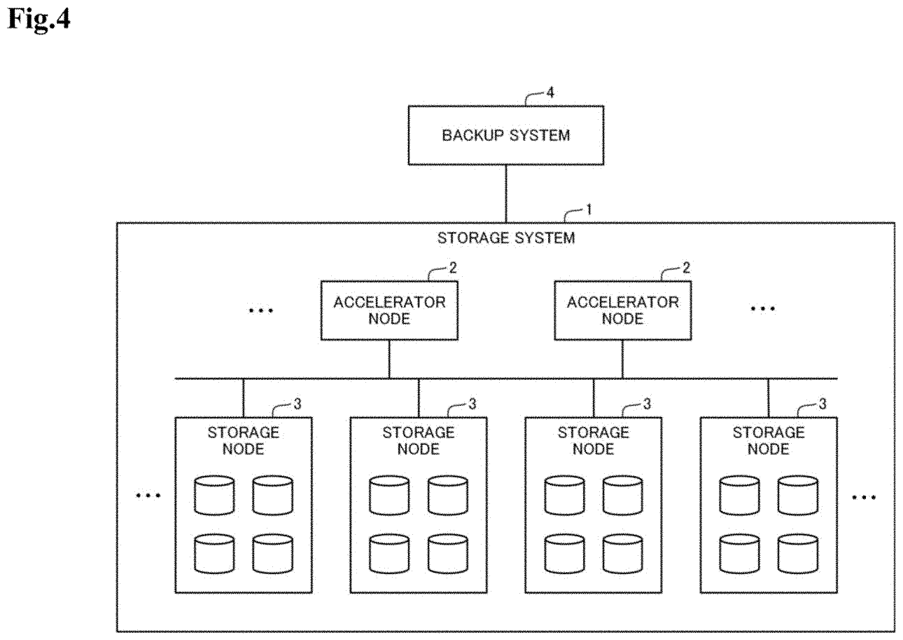

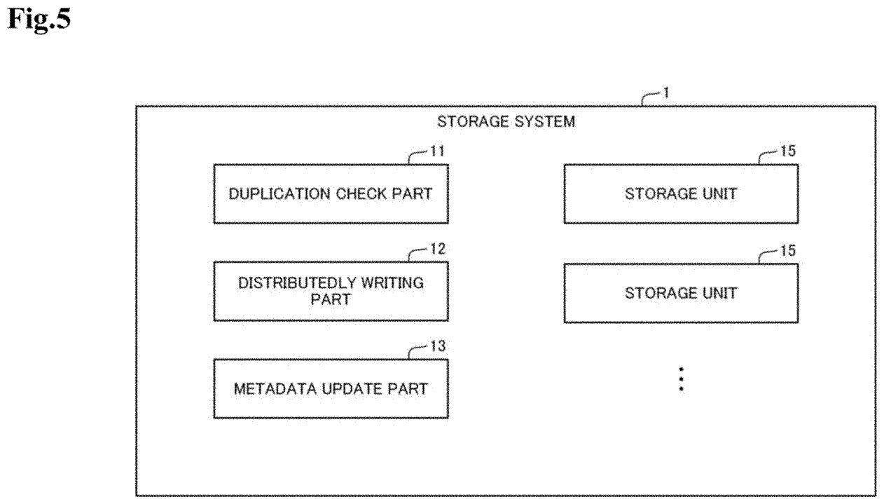

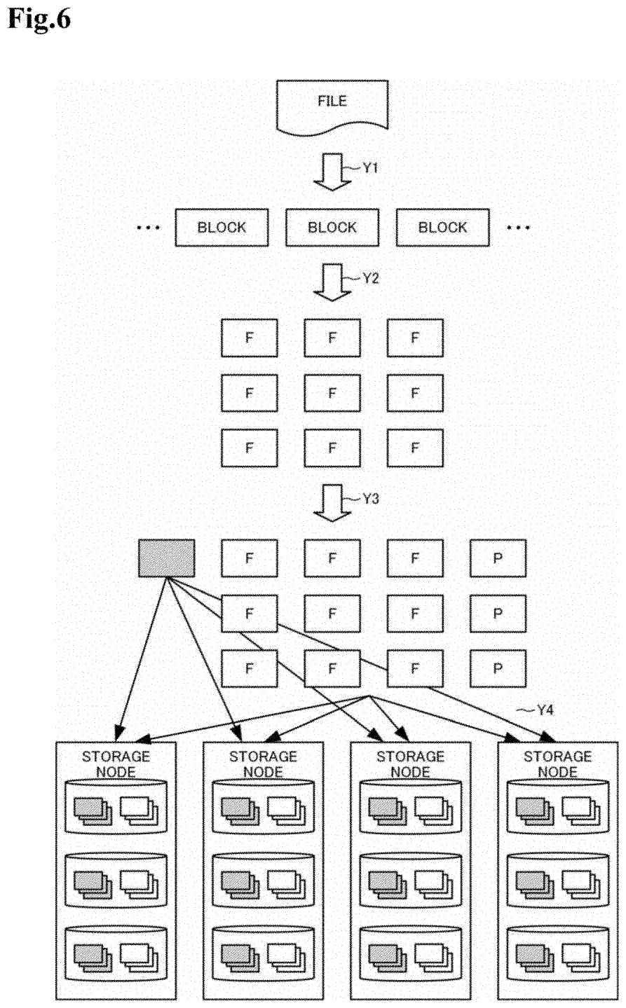

A first example embodiment of the present invention will be described referring to FIGS. 4 to 11. FIGS. 4 and 5 are views for describing the configuration of a storage system, and FIGS. 6 to 11 are views for describing a processing operation of the storage system.

A storage system 1 in this example embodiment is connected to a backup system 4 as shown in FIG. 4. The storage system 1 performs deduplication storage with backup target data stored in the backup system 4 as storage target data. However, the storage system in the present invention is not necessarily limited to being connected to the backup system 4, and the storage target data is not limited to backup target data and may be any data.

Then, the storage system 1 in this example embodiment is configured by a plurality of server computers connected to each other as shown in FIG. 4. To be specific, the storage system 1 includes an accelerator node 2 that is a server computer controlling a storage reproduction operation in the storage system 1, and a storage node 3 that is a server computer including a storage device for storing data. The number of the accelerator nodes 2 and the number of the storage nodes 3 are not limited to those shown in FIG. 4, and the storage system may be configured by more nodes 2 and 3 connected to each other. However, the storage system in the present invention is not limited to being configured by a plurality of computers, and may be configured by one computer.

Below, assuming that the storage system 1 is one system, components and functions included by the storage system 1 will be described. That is, components and functions included by the storage system 1 to be described below may be included by either the accelerator node 2 or the storage node 3. The storage system 1 is not necessarily limited to including the accelerator node 2 and the storage node 3 as shown in FIG. 4, and may have any configuration; for example, may be configured by one computer.

FIG. 5 shows the configuration of the storage system 1 in this example embodiment. The storage system 1 is configured by server computers such as the accelerator nodes 2 and the storage nodes 3 described above, and includes an arithmetic logic unit (not shown) executing predetermined arithmetic processing and a plurality of storage units 15. Then, the storage system 1 includes a duplication check part 11, a distributedly writing part 12, and a metadata update part 13 that are structured by installation of a program into the arithmetic logic unit. As will be described later, the duplication check part 11, the distributedly writing part 12, and the metadata update part 13 have a deduplication function of redundantizing by dividing a storage target file into a plurality of data blocks, distributedly storing the data blocks into the plurality of storage units 15, and specifying a storage location where the data block is stored by a unique content address set in accordance with the content of the data block. Below, the function of the duplication check part 11, the distributedly writing part 12, and the metadata update part 13 will be described in detail together with the operation thereof.

First of all, the outline of a deduplication writing process by the duplication check part 11, the distributedly writing part 12, and the metadata update part 13 will be described referring to FIGS. 6 to 8.

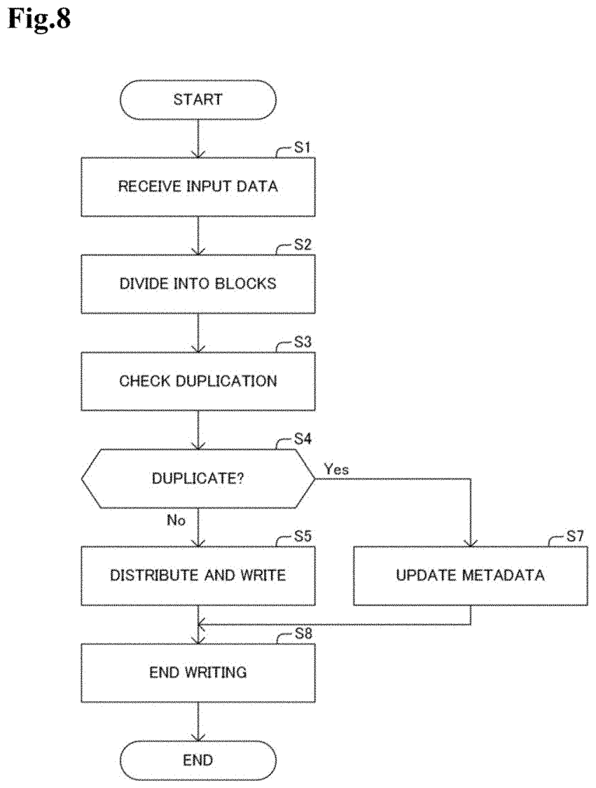

First, the duplication check part 11 (a data writing part) receives a storage target file input from the upper level (step S1 of FIG. 8) and, as shown by an arrow Y1 of FIG. 6, divides the file into a plurality of divided data blocks whose sizes are variable (see FIG. 6, step S2 of FIG. 8). Subsequently, the duplication check part 11 checks whether or not the divided data blocks are duplicated with data blocks already stored in the storage units 15 (step S3 of FIG. 8). The details of a duplication check process will be described later.

In a case where the divided data blocks are not duplicated with the data blocks stored in the storage units 15 (NO at step S4 of FIG. 8), the distributedly writing part 12 (the data writing part) distributedly writes the divided data blocks into the nodes (step S5). The details of processing by the distributedly writing part 12 will be described later.

On the other hand, in a case where the divided data blocks are duplicated with the data blocks stored in the storage units 15 (YES at step S4 of FIG. 8), the metadata update part 13 (the data writing part, a data update part) updates file metadata and block metadata so that the stored data blocks are referred to as the divided data blocks (step S7 of FIG. 8). That is, without storing actual data of the divided data blocks of the storage target into the storage units 15, the metadata update part 13 refers to the already stored data blocks as the divided data blocks and eliminates duplicated storage. The details of processing by the metadata update part 13 will be described later.

When writing of all the data blocks forming the file ends (step S8 of FIG. 8), the storage system 1 returns ACK representing completion of writing to the upper level.

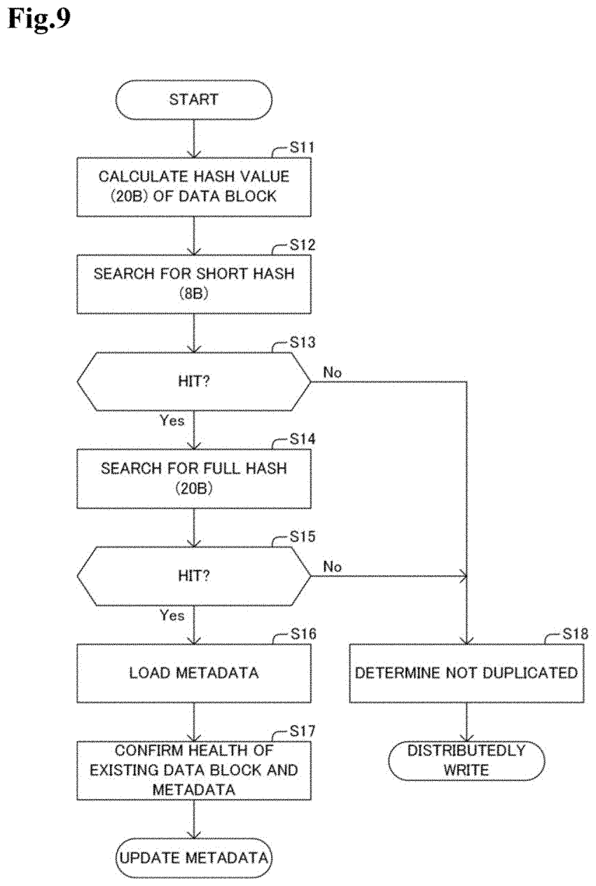

Next, referring to FIG. 9, the details of the duplication check process by the duplication check part 11 will be described. The duplication check part 11 calculates a full hash value (20 bytes) of each of data blocks obtained by dividing a file (step S11 of FIG. 9). A hash value is a unique value representing the data content of the data block based on this data content. For example, a hash value is a value calculated from the data content of the data block using a preset hash function.

Then, the duplication check part 11 retrieves a short hash value that is the top 8 bytes of the full hash value of the data block, and searches a short hash table on a memory to check whether the same value as the short hash value exists (step S12 of FIG. 9). A short hash table is a table in which hash values having been calculated from data blocks already stored in the storage units 15 and having been stored into the storage units 15 are loaded into the memory when the storage system 1 is activated, as will be described later.

In a case where the short hash value of the divided data block does not exist in the short hash table (NO at step S13 of FIG. 9), the duplication check part 11 determines that the divided data block does not exist in the storage units 15 and is not duplicated (step S18 of FIG. 9), and performs distributed writing by the distributedly writing part 12 to be described later. On the other hand, in a case where the short hash value of the divided data block exists in the short hash table (YES at step S13 of FIG. 9), the divided data block may exist in the storage units 15. Therefore, the duplication check part 11 searches a full hash table on a memory to check whether the same value as the full hash value of the divided data block exists (step S14 of FIG. 9). A full hash table is a table in which hash values having been calculated from data blocks already stored in the storage units 15 and having been stored into the storage units 15 are loaded into the memory when the storage system 1 is activated, or a table of hash values stored in the storage devices 15r.

In a case where the full hash value of the divided data block does not exist in the full hash table (NO at step S15 of FIG. 9), the duplication check part 11 determines that the divided data block does not exist in the storage units 15 and is not duplicated (step S18 of FIG. 9), and the distributedly writing part 12 performs distributed writing to be described later. On the other hand, in a case where the full hash value of the divided data block exists in the full hash table (YES at step S15 of FIG. 9), the duplication check part 11 determines that the divided data block already exists in the storage units 15 and is duplicated. Then, the duplication check part 11 retrieves block metadata stored in association with the data blocks stored in the storage units 15 (step S16 of FIG. 9), checks the health of the data blocks and the block metadata (step S17 of FIG. 9), and thereby confirms that the existing data blocks can be loaded. After that, processing by the metadata update part 13, which will be described later, is performed.

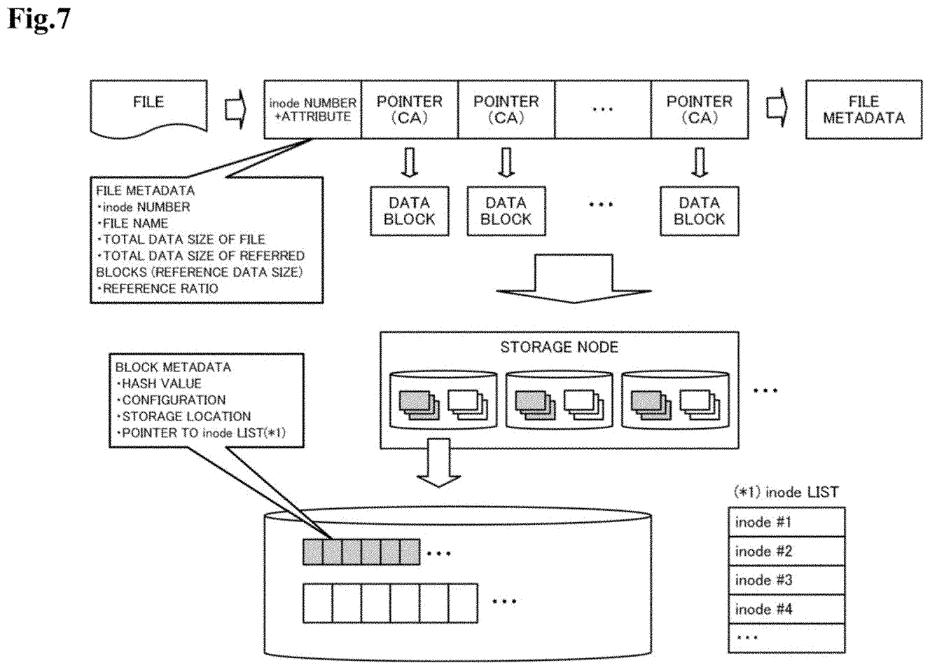

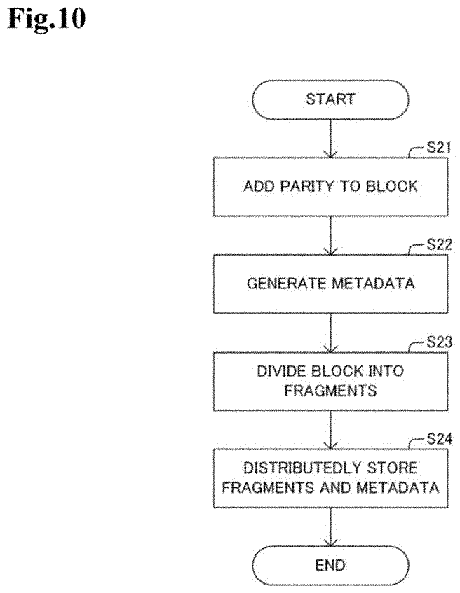

Next, referring to FIGS. 6, 7, and 10, the details of the distributed writing process by the distributedly writing part 12 will be described. The distributedly writing part 12 adds parities to the data blocks obtained by dividing the file as indicated by the arrow Y1 of FIG. 6 in accordance with parity setting (step S21 of FIG. 10). Then, the distributedly writing part 12 generates information to be held in the block metadata (see shaded shapes of FIGS. 6 and 7) of the data blocks (step S22 of FIG. 10). At this time, information to be held in the block metadata includes “full hash value”, “configuration”, “storage location”, and “pointer to inode list” of the data block as shown in FIG. 7. Herein, “full hash value” is a value calculated using a hash function based on the data content of the data block as stated above. Moreover, “configuration” is configuration information such as the data size of the data block, for example. Moreover, “storage location” is information representing the storage location of the data block in the storage units 15. Moreover, “pointer to inode list” is reference information for referring to a storage region where “inode number” (file information) for specifying a division source file from which the data block has been obtained.

Then, the distributedly writing part 12 divides the data block into nine fragments D as indicated by an arrow Y2 of FIG. 6, adds fragment data composed of three parities P as indicated by an arrow 3 of FIG. 6, and thereby generates twelve pieces of fragment data in total (step S23 of FIG. 10). The distributedly writing part 12 distributedly stores the twelve pieces of fragment data D and P and the block metadata (shaded) into the storage units 15 of the respective storage nodes as indicated by an arrow Y4 of FIG. 6 (step S24 of FIG. 10). Herein, twelve duplicates of the block metadata are made, and distributedly stored together with the respective fragment data into the respective storage units 15.

Further, the distributedly writing part 12 generates a content address (CA) that is information for referring to each of the distributedly written data blocks, from the hash value and the storage location stored in the block metadata of the data block. Then, as shown in FIG. 7, the distributedly writing part 12 includes the generated content address CA into file metadata of the division source file. At this time, by also including the inode number and file name for identifying the file into the file metadata and managing by a file system, it is possible to retrieve each of the data blocks obtained by dividing the file and it is possible to restore the file. The file metadata may also be distributedly stored into the respective storage units 15 in the same manner as described above.

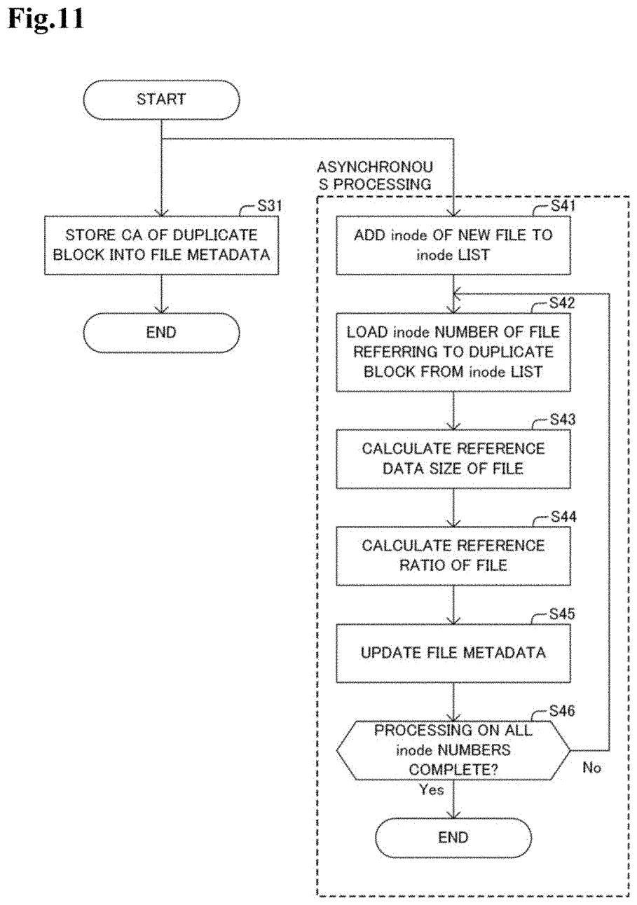

Next, referring to FIGS. 7 and 11, the details of the processing by the metadata update part 13 will be described. The metadata update part 13 performs the following process when it is determined that a divided data block already exists in the storage unit 15 and is duplicated as described above. To be specific, the metadata update part 13 retrieves the block metadata of a data block that is duplicated with the divided data block and is stored in the storage unit 15, and calculates the content address (CA) of the data block from a full hash value and a storage location included in this block metadata. Then, the metadata update part 13 includes the generated content address CA into the file metadata of a division source file and stores this file metadata (step S31 of FIG. 11). As the content address of a duplicate data block, already calculated one may be used.

Further, the metadata update part 13 performs the following process asynchronously with the abovementioned process of allowing a divided data block to be referred to with a content address CA. First, as shown in FIG. 7, the metadata update part 13 adds the inode number of the division source file of the data block determined as duplicated to the inode list (step S41 of FIG. 11). At this time, the metadata update part 13 adds the inode number to the inode list within a storage region to be referred to with a pointer included in the block metadata of the duplicated data block.

Then, the metadata update part 13 retrieves the inode list to be referred to with the pointer included in the block metadata of the data block determined as duplicated, and retrieves the inode number within this Mode list (step S42 of FIG. 11). That is, the metadata update part 13 successively retrieves inode numbers that specify all files referring to the data block.

Subsequently, the metadata update part 13 adds up the data sizes of data blocks for the respective files specified by the inode numbers of the inode list, as a “reference data size” (step S43 of FIG. 11). Herein, as shown in FIG. 7, the “reference data size” is information included in file metadata of each file and is information representing a total data size of data blocks referred to by other files among the data blocks configuring the file. Therefore, as the volume of data blocks referred to by other files among the data blocks configuring the file is larger, the calculated “reference data size” is larger. Then, the metadata update part 13 calculates a “reference ratio” obtained by dividing the “reference data size” by the “total data size” of the file included in the file metadata (step S44 of FIG. 11), includes the reference ratio into the file metadata, and thereby updates the file metadata (step S45 of FIG. 11). That is, the metadata update part 13 calculates a file reference ratio=(size of referred data of file)/(size of total data of file). The metadata update part 13 repeatedly performs the abovementioned process until it finishes the process on all the files with the inode numbers in the list (step S46 of FIG. 11).

As stated above, in the storage system 1 of the present invention, a pointer to inode list that specifies a file referring to the data block is included in the block metadata, and a reference ratio of each file is included in the file metadata. With this, it is possible to trace the reference conditions of the respective files at all times, and it is possible to instantly and accurately grasp a duplication/reference condition among the files. As a result, it is possible to easily grasp an effect resulting from acquisition of a free space by file deletion or from tiering operation in the deduplication storage system.

Further, by performing writing into the inode list and calculation of the reference ratio as background processing asynchronously with I/O processing of data writing, it is possible to limit overhead and suppress decrease of I/O processing performance. Even if inconsistency is temporarily caused by occurrence of failure because of asynchronous writing, it does not affect the safety of data. In case of occurrence of such inconsistency, it is possible to regularly check in the background processing and eliminate inconsistency. Moreover, it is possible to limit memory usage by storing the inode list not in the memory but in the storage unit 15.

### Second Example Embodiment

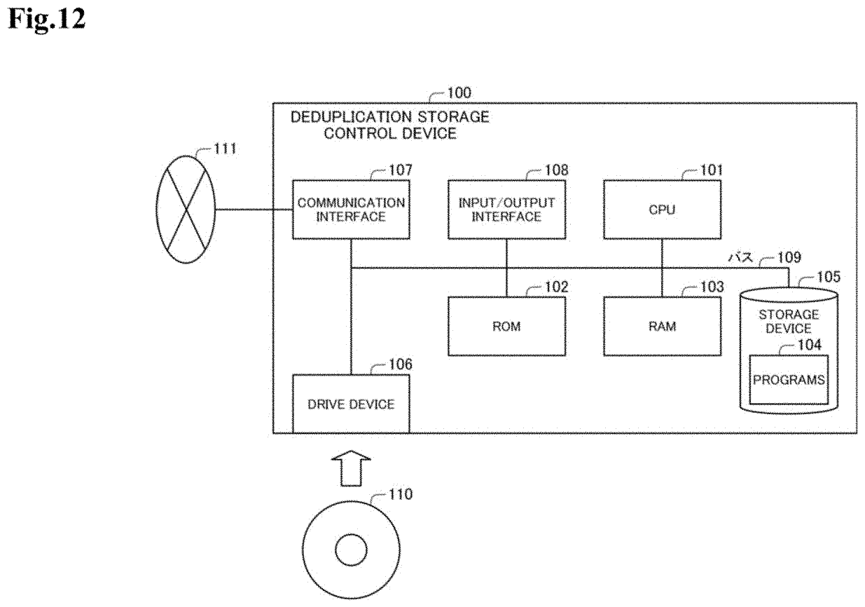

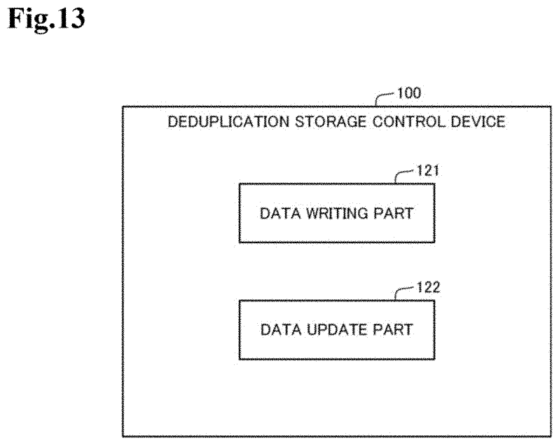

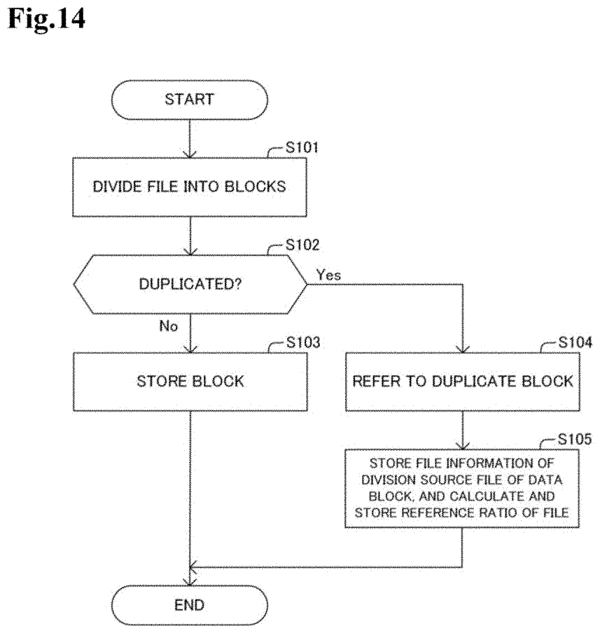

Next, a second example embodiment of the present invention will be described referring to FIGS. 12 to 14. FIGS. 12 and 13 are block diagrams showing the configuration of a deduplication storage control device in the second example embodiment, and FIG. 14 is a flowchart showing the operation of the deduplication storage control device. In this example embodiment, the outline of the configuration of the deduplication storage system and the processing method by the deduplication storage system described in the first example embodiment is shown.

First, referring to FIG. 12, the hardware configuration of a deduplication storage control device 100 in this example embodiment will be described. The deduplication storage control device 100 is configured by a general information processing device, and includes a hardware configuration as shown below as an example:

a CPU (Central Processing Unit) 101 (arithmetic logic unit);

a ROM (Read Only Memory) 102 (storage unit);

a RAM (Random Access Memory) 103 (storage unit);

Programs 104 loaded to the RAM 103;

a storage device 105 for storing the programs 104;

a drive device 106 that performs reading from and writing into a storage medium 110 outside the information processing device;

a communication interface 107 connected to a communication network 111 outside the information processing device; and

a bus 109 connecting the components.

The deduplication storage control device 100 can structure and include a data writing part 121 and a data update part 122 shown in FIG. 13 by causing the CPU 101 to acquire the programs 104 and cause the CPU 101 to execute the programs 104. For example, the programs 104 are stored in advance in the storage device 105 or the ROM 102, and the CPU 101 loads the programs 104 into the RAM 103 and executes as necessary. The programs 104 may be provided to the CPU 101 via the communication network 111. Alternatively, the programs 104 may be stored in advance in the storage medium 110, and read out by the drive device 106 and provided to the CPU 111. Meanwhile, the data writing part 121 and the data update part 122 described above may be structured by electronic circuits.

FIG. 12 shows an example of the hardware configuration of the information processing device serving as the deduplication storage control device 100, and the hardware configuration of the information processing device is not limited to the abovementioned one. For example, the information processing device may be configured by part of the abovementioned configuration, for example, excluding the drive device 106.

Then, the deduplication storage control device 100 executes a deduplication storage method shown in the flowchart of FIG. 14 by the functions of the data writing part 121 and the data update part 122 structured by the programs as described above.

As shown in FIG. 14, the deduplication storage control device 100:

divides a storage target file into a plurality of divided data blocks (step S101);

in a case where a divided data block of the divided data blocks is not duplicated with any data block of data blocks stored in a storage device (NO at step S102), stores the divided data block into the storage device (step S103);

in a case where a divided data block of the divided data blocks is duplicated with any data block of the data blocks stored in the storage device (YES at step S102), refers to the data block stored in the storage device as the divided data block (step S104); and

stores file information specifying a division source file of each of the data blocks stored in the storage device in association with the data block, and also calculates a reference ratio representing a ratio at which a certain file is referred to by other files based on the file information stored in association with the data blocks and stores the reference ratio in association with the certain file (step S105).

As stated above, according to the present invention, file information of a division source file is stored in association with a data block, and a reference ratio representing a ratio at which the file is referred to is calculated and stored in association with the file. With this, it is possible to trace the reference condition of each file at all times, and it is possible to instantly and accurately grasp the duplication/reference condition among files. As a result, it is possible to allow a device having the deduplication function to easily grasp an effect resulting from acquisition of a free space by file deletion or from tiering operation.

### SUPPLEMENTARY NOTES

The whole or part of the example embodiments disclosed above can be described as the following supplementary notes. Below, the outline of the configurations of the deduplication storage method, the deduplication storage device, the deduplication storage system, and the program according to the present invention will be described. However, the present invention is not limited to the following configurations.

### Supplementary Note 1

A deduplication storage method comprising:

dividing a storage target file into a plurality of divided data blocks;

in a case where a divided data block is not duplicated with a data block stored in a storage device, storing the divided data block into the storage device;

in a case where the divided data block is duplicated with the data block stored in the storage device, performing a process of referring to the data block stored in the storage device as the divided data block; and

performing a process of storing file information specifying a division source file of the data block stored in the storage device in association with the said data block, and also performing a process of calculating a reference ratio representing a ratio at which a certain file is referred to by other files based on the file information stored in association with the data block and storing the reference ratio in association with the certain file.

### Supplementary Note 2

The deduplication storage method according to Supplementary Note 1, wherein the process of storing the file information and the process of calculating and storing the reference ratio are performed asynchronously with the process of referring to the data block stored in the storage device as the divided data block.

### Supplementary Note 3

The deduplication storage method according to Supplementary Note 1 or 2, wherein the file information is stored in a certain storage region to which a pointer refers, the pointer being included in metadata of the data block stored in the storage device.

### Supplementary Note 4

The deduplication storage method according to Supplementary Note 3, wherein the pointer is included in the metadata, the metadata including feature information that represents a feature of a data content of the data block and is used for duplication determination of the said data block.

### Supplementary Note 5

The deduplication storage method according to any of Supplementary Notes 1 to 3, wherein based on the file information stored in association with the data block, a data size of the data block referred to by other files among the data blocks configuring a certain file is calculated, and the reference ratio is calculated based on the data size and stored in association with the file.

### Supplementary Note 6

The deduplication storage method according to Supplementary Note 5, wherein the reference ratio is stored in metadata of the file, the metadata including the file information of the file and storage location information representing a storage location in the storage device of the data block configuring the file.

### Supplementary Note 7

A deduplication storage control device comprising:

a data writing part configured to divide a storage target file into a plurality of divided data blocks, in a case where a divided data block is not duplicated with a data block stored in a storage device, store the divided data block into the storage device, and in a case where the divided data block is duplicated with the data block stored in the storage device, perform a process of referring to the data block stored in the storage device as the divided data block; and

a data update part configured to store file information specifying a division source file of the data block stored in the storage device in association with the said data block, and also calculate a reference ratio representing a ratio at which a certain file is referred to by other files based on the file information stored in association with the data block and store the reference ratio in association with the certain file.

### Supplementary Note 8

A deduplication storage system comprising a plurality of storage devices and a deduplication storage control device executing control to distribute, deduplicate, and store a storage target file into the plurality of storage devices,

the deduplication storage control device including:

a data writing part configured to divide a storage target file into a plurality of divided data blocks, in a case where a divided data block is not duplicated with a data block stored in a storage device, store the divided data block into the storage device, and in a case where the divided data block is duplicated with the data block stored in the storage device, perform a process of referring to the data block stored in the storage device as the divided data block; and

a data update part configured to store file information specifying a division source file of the data block stored in the storage device in association with the said data block, and also calculate a reference ratio representing a ratio at which a certain file is referred to by other files based on the file information stored in association with the data block and store the reference ratio in association with the certain file.

### Supplementary Note 14

A non-transitory computer-readable storage medium storing a program comprising instructions for causing an information processing device to realize:

divide a storage target file into a plurality of divided data blocks, in a case where a divided data block is not duplicated with a data block stored in a storage device, store the divided data block into the storage device, and in a case where the divided data block is duplicated with the data block stored in the storage device, perform a process of referring to the data block stored in the storage device as the divided data block; and

store file information specifying a division source file of the data block stored in the storage device in association with the said data block, and also calculate a reference ratio representing a ratio at which a certain file is referred to by other files based on the file information stored in association with the data block and store the reference ratio in association with the certain file.

The program described above can be stored using various types of non-transitory computer-readable mediums and provided to a computer. The non-transitory computer-readable mediums include various types of tangible storage mediums. The non-transitory computer-readable mediums are, for example, a magnetic recording medium (for example, a flexible disk, a magnetic tape, a hard disk drive), a magnetooptical recording medium (for example, a magnetooptical disk), a CD-ROM (Read Only Memory), CR-R, CD-R/W, a semiconductor memory (for example, a mask ROM, PROM (Programmable ROM), EPROM (Erasable PROM), and a flash ROM, RAM (Random Access Memory)). Moreover, the program may be provided to a computer by various types of transitory computer-readable mediums. The transitory computer-readable mediums are, for example, electric signals, optic signals, and electromagnetic waves. The transitory computer-readable mediums can provide the program to a computer via a wired communication path such as electric wires or optical fibers, or via a wireless communication path.

Although the present invention has been described above referring to the above example embodiments and so on, the present invention is not limited to the above example embodiments. The configurations and details of the present invention can be changed in various manners that can be understood by one skilled in the art within the scope of the present invention.

### DESCRIPTION OF REFERENCE NUMERALS

1 storage system
2 accelerator node
3 storage node
4 backup system
11 duplication check part
12 distributedly writing part
13 metadata update part
15 storage unit
100 deduplication storage control device
101 CPU
102 ROM
103 RAM
104 programs
105 storage device
106 drive device
107 communication interface
108 input/output interface
109 bus
110 storage medium
111 communication network
121 data writing part
122 data update part

1. A deduplication storage method comprising:
dividing a storage target file into a plurality of divided data blocks;
in a case where a divided data block is not duplicated with a data block stored in a storage device, storing the divided data block into the storage device;
in a case where the divided data block is duplicated with the data block stored in the storage device, performing a process of referring to the data block stored in the storage device as the divided data block; and
performing a process of storing file information specifying a division source file of the data block stored in the storage device in association with the said data block, and also performing a process of calculating a reference ratio representing a ratio at which a certain file is referred to by other files based on the file information stored in association with the data block and storing the reference ratio in association with the certain file.

2. The deduplication storage method according to claim 1, wherein the process of storing the file information and the process of calculating and storing the reference ratio are performed asynchronously with the process of referring to the data block stored in the storage device as the divided data block.

3. The deduplication storage method according to claim 1, wherein the file information is stored in a certain storage region to which a pointer refers, the pointer being included in metadata of the data block stored in the storage device.

4. The deduplication storage method according to claim 3, wherein the pointer is included in the metadata, the metadata including feature information that represents a feature of a data content of the data block and is used for duplication determination of the said data block.

5. The deduplication storage method according to claim 1, wherein based on the file information stored in association with the data block, a data size of the data block referred to by other files among the data blocks configuring a certain file is calculated, and the reference ratio is calculated based on the data size and stored in association with the file.

6. The deduplication storage method according to claim 5, wherein the reference ratio is stored in metadata of the file, the metadata including the file information of the file and storage location information representing a storage location in the storage device of the data block configuring the file.

7. A deduplication storage control device comprising at least one memory storing instructions and at least one processor,
wherein the at least one processor is configured to execute the instructions to:
divide a storage target file into a plurality of divided data blocks, in a case where a divided data block is not duplicated with a data block stored in a storage device, store the divided data block into the storage device, and in a case where the divided data block is duplicated with the data block stored in the storage device, perform a process of referring to the data block stored in the storage device as the divided data block; and
perform a process of storing file information specifying a division source file of the data block stored in the storage device in association with the said data block, and also perform a process of calculating a reference ratio representing a ratio at which a certain file is referred to by other files based on the file information stored in association with the data block and storing the reference ratio in association with the certain file.

8. The deduplication storage control device according to claim 7, wherein the process of storing the file information and the process of calculating and storing the reference ratio are performed asynchronously with the process of referring to the data block stored in the storage device as the divided data block.

9. The deduplication storage control device according to claim 7, wherein the file information is stored in a certain storage region to which a pointer refers, the pointer being included in metadata of the data block stored in the storage device.

10. The deduplication storage control device according to claim 9, wherein the pointer is included in the metadata, the metadata including feature information that represents a feature of a data content of the data block and is used for duplication determination of the said data block.

11. The deduplication storage control device according to claim 7, wherein based on the file information stored in association with the data block, a data size of the data block referred to by other files among the data blocks configuring a certain file is calculated, and the reference ratio is calculated based on the data size and stored in association with the file.

12. The deduplication storage control device according to claim 11, wherein the reference ratio is stored in metadata of the file, the metadata including the file information of the file and storage location information representing a storage location in the storage device of the data block configuring the file.

13. A deduplication storage system comprising a plurality of storage devices and a deduplication storage control device executing control to distribute, deduplicate, and store a storage target file into the plurality of storage devices,
the deduplication storage control device including at least one memory storing instructions and at least one processor,
wherein the at least one processor is configured to execute the instructions to:
divide a storage target file into a plurality of divided data blocks, in a case where a divided data block is not duplicated with a data block stored in a storage device, store the divided data block into the storage device, and in a case where the divided data block is duplicated with the data block stored in the storage device, perform a process of referring to the data block stored in the storage device as the divided data block; and
store file information specifying a division source file of the data block stored in the storage device in association with the said data block, and also calculate a reference ratio representing a ratio at which a certain file is referred to by other files based on the file information stored in association with the data block and store the reference ratio in association with the certain file.
